(19) United States
(12) Patent Application Publication
(10) Pub. No.: US 2025/0012992 A1
(43) Pub. Date: Jan. 9, 2025

(54) OPTICAL CABLE STRUCTURE AND OPTICAL CABLE STRUCTURE PRODUCTION METHOD

(71) Applicant: Fujikura Ltd., Tokyo (JP)

(72) Inventors: Shuhei Kanno, Sakura-shi (JP); Kansei Shindo, Sakura-shi (JP)

(73) Assignee: Fujikura Ltd., Tokyo (JP)

(21) Appl. No.: 18/706,601

(22) PCT Filed: Jun. 29, 2022
(86) PCT No.: PCT/JP2022/025859

§ 371 Date: May 1, 2024

(30) Foreign Application Priority Data
Dec. 8, 2021 (JP) 2021-199309

(51) Int. Cl. G02B 6/44; G02B 6/02; G02B 6/255; G02B 6/38

(52) U.S. Cl. CPC G02B 6/443; G02B 6/02042; G02B 6/2551; G02B 6/3885; G02B 6/4486

(57) ABSTRACT

An optical cable structure includes connector-equipped optical fibers, derived from an end portion of a sheath of an optical cable, that are accommodated in a tubular member. Each of the connector-equipped optical fibers includes a derivation optical fiber from the end portion of the sheath and an optical connector disposed at a distal portion of the derivation optical fiber. Lengths of at least some of the derivation optical fibers are different from each other. Each of the derivation optical fibers includes a proximal-side optical fiber on an end portion side of the sheath, a distal-side optical fiber on an optical connector side, and a connecting portion connecting the proximal-side optical fiber to the distal-side optical fiber. The connecting portions are disposed in the tubular member when the connector-equipped optical fibers are accommodated in the tubular member.

### CROSS-REFERENCE TO RELATED APPLICATIONS

The present application is a national phase application of International Application No. PCT/JP2022/025859, filed Jun. 29, 2022, which claims priority to Japanese Patent Application No. 2021-199309, filed Dec. 8, 2021. The contents of these applications are incorporated herein by reference in their entirety.

### BACKGROUND

### Technical Field

The present invention relates to an optical cable structure and a method for producing the optical cable structure.

### Discussion of the Background

In the related art, when an optical cable is inserted into a duct to install optical wiring lines, a distal portion of the optical cable is protected by being accommodated in a tubular member (traction end). A plurality of optical fibers in which an optical connector is terminated at each distal portion are accommodated as the distal portion of the optical cable inside the tubular member.

Patent Document 1 discloses an optical cable structure in which the lengths of a plurality of optical fibers constituting a distal portion of an optical cable are made different from each other, and a plurality of optical connectors terminated at the plurality of optical fibers are disposed out of alignment in a length direction of the optical fiber (optical cable). In such an optical cable structure, it is possible to suppress the bulkiness of the plurality of optical connectors in a radial direction of the optical cable to maintain a small diameter dimension of the tubular member accommodating the plurality of optical connectors. For this reason, even if the number of optical fibers each having the optical connector at the distal portion is large, the optical cable can be inserted into a narrow duct.

### Patent Document

Patent Document 1: Japanese Patent Publication No. 2002-333561

However, in a case where an attempt to produce the optical cable structure disclosed in Patent Document 1 is made, it is difficult to efficiently perform the termination work of the optical connector for the distal portion of each of the plurality of optical fibers. For example, in order to efficiently perform the termination work of the optical connector, it is preferable that the positions of the distal portions of the plurality of optical fibers are aligned. However, because the lengths of the plurality of optical fibers are different from each other, it is difficult to align the positions of the distal portions of the plurality of optical fibers.

### SUMMARY

One or more embodiments provide an optical cable structure and a method for producing the optical cable structure capable of easily performing the termination work of optical connectors for a plurality of optical fibers constituting a distal portion of an optical cable accommodated in a tubular member.

An optical cable structure according to one or more embodiments is an optical cable structure including a plurality of connector-equipped optical fibers which are derived from an end portion of a sheath of an optical cable and accommodated in a tubular member having a predetermined length. Each of the plurality of connector-equipped optical fibers includes a derivation optical fiber derived from the end portion of the sheath, and an optical connector provided at a distal portion of the derivation optical fiber in a derivation direction. Lengths of at least some derivation optical fibers among a plurality of the derivation optical fibers derived from the end portion of the sheath are different from each other. Each of the plurality of derivation optical fibers has a proximal-side optical fiber located on an end portion side of the sheath, a distal-side optical fiber located on an optical connector side, and a connecting portion connecting the proximal-side optical fiber and the distal-side optical fiber to each other. The connecting portions of the plurality of derivation optical fibers are located inside the tubular member in a state where the plurality of connector-equipped optical fibers are accommodated in the tubular member.

A method for producing an optical cable structure according to one or more embodiments is a method for producing an optical cable structure including a plurality of connector-equipped optical fibers which are derived from an end portion of a sheath of an optical cable and accommodated in a tubular member having a predetermined length, the method comprising: a first step of terminating an optical connector at a first end portion of a distal-side optical fiber in a longitudinal direction; a second step of leading out a plurality of proximal-side optical fibers from the end portion of the sheath; and a third step of connecting a second end portion of each of a plurality of the distal-side optical fibers in the longitudinal direction to a distal portion of each of the plurality of proximal-side optical fibers after the first step and the second step to form the plurality of connector-equipped optical fibers each having a derivation optical fiber including the proximal-side optical fiber and a distal-side optical fiber, and the optical connector, and extending from the end portion of the sheath. At least one of lengths of the plurality of proximal-side optical fibers and lengths of the plurality of distal-side optical fibers is set before the third step such that lengths of at least some derivation optical fibers among a plurality of the derivation optical fibers derived from the end portion of the sheath are different from each other.

According to one or more embodiments, it is possible to easily perform the termination work of the optical connectors for the plurality of derivation optical fibers that constitute the distal portion of the optical cable and are accommodated in the tubular member.

### BRIEF DESCRIPTION OF THE DRAWINGS

FIG. 1 is a sectional view showing an optical cable structure according to a first example of one or more embodiments and a state where a plurality of connector-equipped optical fibers constituting the optical cable structure are accommodated in a tubular member.

FIG. 2 is a perspective view showing a state where the plurality of connector-equipped optical fibers are taken out from the tubular member in FIG. 1.

FIG. 3 is a perspective view showing a connector-equipped optical fiber in FIGS. 1 and 2 in an enlarged manner.

FIG. 4 is a sectional view taken along line IV-IV in FIG. 3.

FIG. 5 is a sectional view taken along line V-V of FIG. 3.

FIG. 6 is a sectional view taken along line VI-VI in FIG. 3.

FIG. 7 is an exploded perspective view of the connector-equipped optical fiber of FIG. 3.

FIG. 8 is a view showing a process for producing the optical cable structure according to the first example.

FIG. 9 is a sectional view showing an optical cable structure according to a second example of one or more embodiments and a state where a plurality of connector-equipped optical fibers constituting the optical cable structure are accommodated in a tubular member.

FIG. 10 is a plan view showing a connector-equipped optical fiber in FIG. 9 in an enlarged manner.

FIG. 11 is a perspective view showing a state in which the connector-equipped optical fiber in FIG. 10 is separated into a proximal-side optical fiber, a distal-side optical fiber, and a fusion-splicing portion.

FIG. 12 is a view showing a process for producing an optical cable structure according to the second example.

### DESCRIPTION OF THE EMBODIMENTS

### First Example

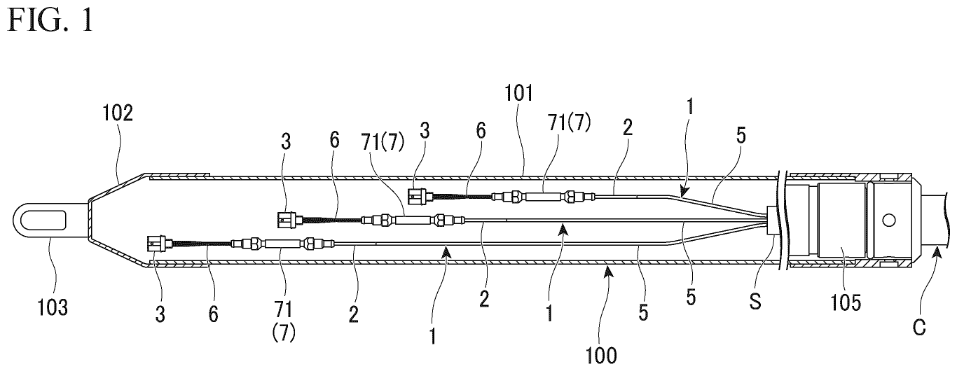

Hereinafter, a first example of one or more embodiments will be described with reference to FIGS. 1 to 8.

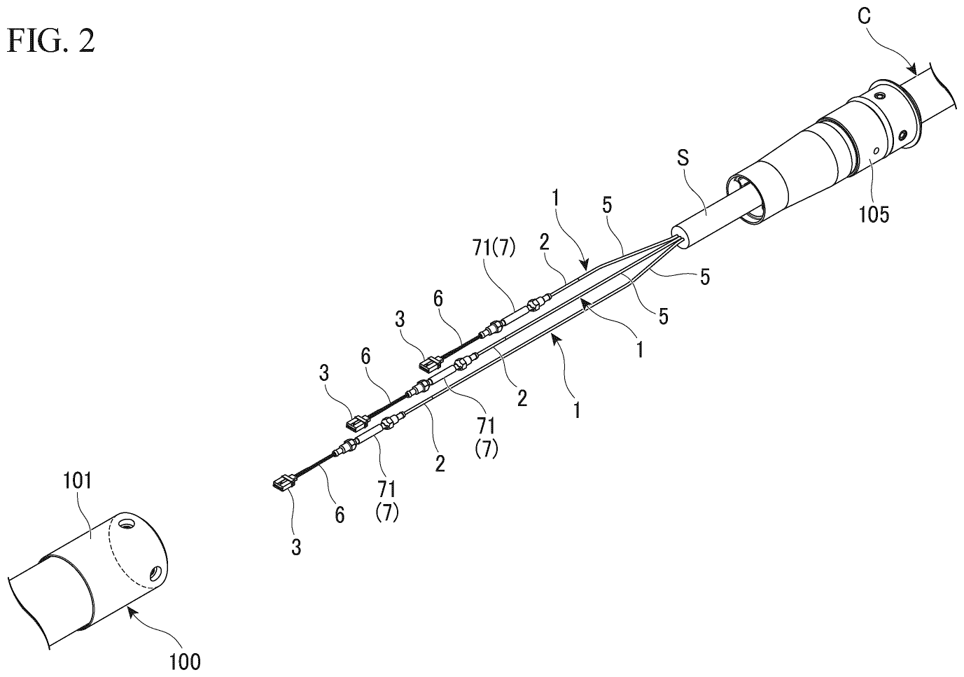

As shown in FIGS. 1 and 2, an optical cable structure of the first example has a plurality of connector-equipped optical fibers 1 that are derived from an end portion of a sheath S of an optical cable C and constitute a distal portion of the optical cable C. In the shown example, the number of connector-equipped optical fibers 1 is three, but the present invention is not limited thereto. The plurality of connector-equipped optical fibers 1 are accommodated in a tubular member 100 having a predetermined length.

As shown in FIG. 1, the tubular member 100 covers the plurality of connector-equipped optical fibers 1. The tubular member 100 has the role of protecting the plurality of connector-equipped optical fibers 1 when the optical cable C passes through a duct or the like of a building. In addition, the tubular member 100 also has the role as a traction end that is tractioned when the optical cable C passes through the duct or the like. The tubular member 100 is removed from the optical cable C after the optical cable C passes through the duct or the like.

The tubular member 100 has a tubular main body 101 and a head 102. The tubular main body 101 is formed in a tubular shape that accommodates the connector-equipped optical fibers 1. The tubular main body 101 may have, for example, flexibility. The head 102 is provided at a distal portion of the tubular main body 101 and covers an opening on the distal side of the tubular main body 101. A pulling eye 103 is provided at the distal end of the head 102. By binding and pulling a rope or the like to the pulling eye 103, the optical cable C can easily pass through the duct or the like.

The tubular member 100 is detachably attached to the optical cable C by accommodating the plurality of connector-equipped optical fibers 1 in the tubular main body 101 and then causing a proximal portion of the tubular main body 101 to be held by a holding tool 105 fixed to the end portion of the sheath S with a screw or the like.

As shown in FIGS. 1 to 3, each connector-equipped optical fiber 1 of the optical cable C has a derivation optical fiber 2 derived from the end portion of the sheath S and an optical connector 3 provided at a distal portion of the derivation optical fiber 2 in a derivation direction.

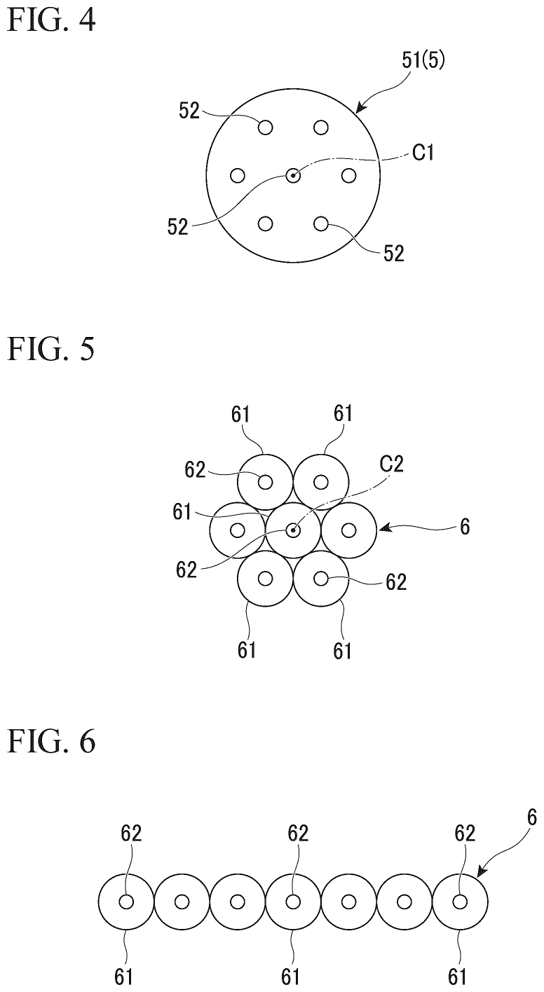

The derivation optical fiber 2 has cores 52 and 62 (see FIGS. 4 to 6) for transmitting optical signals. Although the number of the cores 52 and 62 in the derivation optical fiber 2 may be, for example, one, the number thereof in the present example is more than one.

The derivation optical fiber 2 has a proximal-side optical fiber 5, a distal-side optical fiber 6, and a connecting portion 7.

The proximal-side optical fiber 5 is a portion on the proximal side of the derivation optical fiber 2 located on the end portion side of the sheath S. As shown in FIG. 4, the proximal-side optical fiber 5 in the present example is a multi-core fiber 51 having a plurality of (seven in the shown example) cores 52. The plurality of cores 52 constituting the multi-core fiber 51 are disposed on the same circumference centered on an axis C1 of the proximal-side optical fiber 5 when viewed from a longitudinal direction of the proximal-side optical fiber 5, and are arranged at intervals around the axis C1. In addition, in the multi-core fiber 51 of the shown example, one core 52 is disposed on the axis C1 of the proximal-side optical fiber 5.

As shown in FIGS. 1 to 3, the distal-side optical fiber 6 is a portion on the distal side of the derivation optical fiber 2 located on the optical connector 3 side. As shown in FIGS. 5 and 6, the distal-side optical fiber 6 in the present example is configured by a plurality of (seven in the shown example) single-core fibers 61 each having one core 62. The number of single-core fibers 61 constituting the distal-side optical fiber 6 corresponds to the number of cores 52 (see FIG. 4) of the multi-core fiber 51 constituting the proximal-side optical fiber 5.

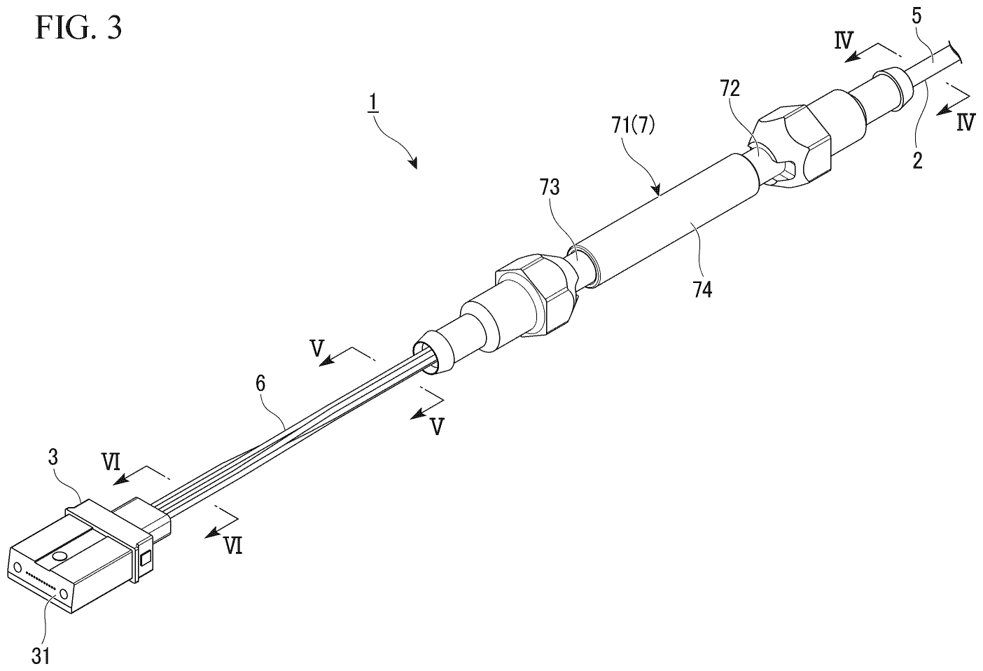

As shown in FIG. 5, the plurality of single-core fibers 61 are arranged at a proximal portion (second end portion) 6B, in the longitudinal direction, of the distal-side optical fiber 6 located on the proximal-side optical fiber 5 side as shown in FIG. 3 to correspond to the arrangement of the plurality of cores 52 of the proximal-side optical fiber 5 shown in FIG. 4. Specifically, at the proximal portion of the distal-side optical fiber 6, as shown in FIG. 5, the plurality of single-core fibers 61 are disposed on the same circumference centered on a predetermined axis C2. In addition, one single-core fiber 61 is disposed to be located on the predetermined axis C2.

On the other hand, as shown in FIG. 6, a plurality of single-core fibers 61 are arranged at a distal portion (first end portion) 6A, in the longitudinal direction, of the distal-side optical fiber 6 located on the optical connector 3 side as shown in FIG. 3 to correspond to the optical connector 3 (ferrule). Specifically, as shown in FIG. 6, the plurality of single-core fibers 61 are arranged in a line in a linear direction (left-right direction in FIG. 6) perpendicular to the longitudinal direction thereof at a distal portion of the distal-side optical fiber 6.

As shown in FIGS. 1 to 3, the connecting portion 7 connects the proximal-side optical fiber 5 and the distal-side optical fiber 6 to each other. The connecting portion 7 has the role of optically coupling the plurality of cores 52 (see FIG. 4) of the proximal-side optical fiber 5 and the plurality of cores 62 (see FIG. 5) of the distal-side optical fiber 6 to each other individually. The connecting portion 7 of the present example is a connector connecting portion 71 that mechanically connects the proximal-side optical fiber 5 and the distal-side optical fiber 6 to each other.

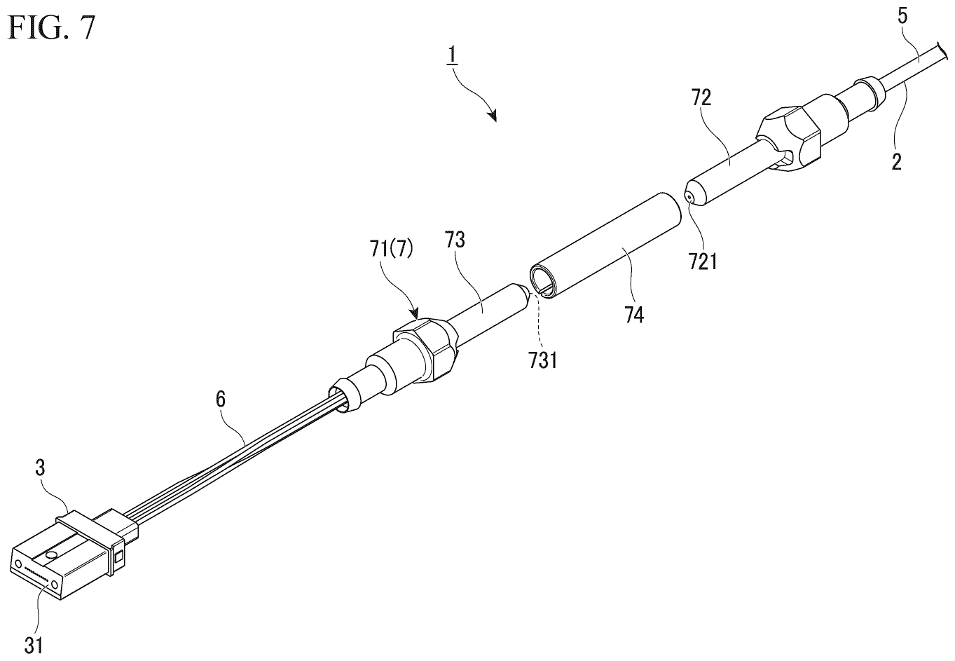

As shown in FIGS. 3 and 7, the connector connecting portion 71 has a proximal-side connector 72, a distal-side connector 73, and an adapter 74.

The proximal-side connector 72 is provided at a distal portion of the proximal-side optical fiber 5 and has a connection surface 721 where the distal end of the proximal-side optical fiber 5 is exposed. Although not shown, an insertion hole is formed in the proximal-side connector 72. The distal portion of the proximal-side optical fiber 5 is inserted through the insertion hole and is exposed from the connection surface 721 of the proximal-side connector 72.

The distal-side connector 73 is provided at a proximal portion of the distal-side optical fiber 6 and has a connection surface 731 from which a proximal end of the distal-side optical fiber 6 is exposed. Although not shown, an insertion hole is formed in the distal-side connector 73. The proximal portion of the distal-side optical fiber 6 is inserted through the insertion hole and is exposed from the connection surface 731 of the distal-side connector 73.

The adapter 74 connects the proximal-side connector 72 and the distal-side connector 73 to each other to optically couple the cores 52 (see FIG. 4) of the proximal-side optical fiber 5 and the cores 62 (see FIG. 5) of the distal-side optical fiber 6. The adapter 74 of the present example is formed in a tubular shape in which both ends in the axial direction are open. The proximal-side connector 72 and the distal-side connector 73 are inserted into openings at both ends of the adapter 74 such that the connection surfaces 721 and 731 of the proximal-side connector 72 and the distal-side connector 73 face each other. Accordingly, it is possible to butt the connection surfaces 721 and 731 of the proximal-side connector 72 and the distal-side connector 73 against each other to optically couple the cores 52 of the proximal-side optical fiber 5 and the cores 62 of the distal-side optical fiber 6 to each other.

As shown in FIGS. 1 and 2, the lengths of the plurality of derivation optical fibers 2 derived from the end portion of the sheath S are different from each other. In the present example, the lengths of all the derivation optical fibers 2 are different from each other. In addition, the lengths of the plurality of proximal-side optical fibers 5 constituting the plurality of derivation optical fibers 2 are different from each other.

Moreover, the lengths of the plurality of distal-side optical fibers 6 constituting the plurality of derivation optical fibers 2 are equal to each other.

Since the lengths of the plurality of proximal-side optical fibers 5 constituting the plurality of derivation optical fibers 2 are different from each other, the plurality of connecting portions 7 (connector connecting portions 71) located at the distal portions of the plurality of proximal-side optical fibers 5 are located out of alignment in the derivation direction of the derivation optical fibers 2.

The optical connector 3 is provided at the distal portion of each derivation optical fiber 2 in the derivation direction, that is, provided at the distal portion of each distal-side optical fiber 6. As shown in FIG. 3, the optical connector 3 has a connection end face 31 where the distal end of the distal-side optical fiber 6 is exposed. Although not shown, an insertion hole is formed in the optical connector 3. The distal portion of the distal-side optical fiber 6 is inserted through the insertion hole and is exposed from the connection end face 31 of the optical connector 3. In the present example, the insertion hole of the optical connector 3 is formed such that the plurality of single-core fibers 61 are inserted therethrough in a state where the plurality of single-core fibers 61 (see FIG. 6) constituting the distal-side optical fiber 6 are arranged in a line in a linear direction perpendicular to the longitudinal direction thereof.

As described above, the lengths of the plurality of derivation optical fibers 2 derived from the end portion of the sheath S are different from each other. For this reason, the plurality of optical connectors 3 provided at the corresponding distal portions of the plurality of derivation optical fibers 2 are located out of alignment in the derivation direction of the derivation optical fibers 2.

As shown in FIG. 1, the connecting portions 7 of all the derivation optical fibers 2 are located inside the tubular member 100 in a state where the plurality of connector-equipped optical fibers 1 of the optical cable C configured are accommodated in the tubular member 100.

In addition, the lengths of all of the connector-equipped optical fibers 1 are shorter than the length of the tubular member 100.

Accordingly, the connector-equipped optical fibers 1 can be accommodated in the tubular member 100 without bending or the like of all the derivation optical fibers 2.

Next, a method for producing the optical cable structure according to the present example will be described.

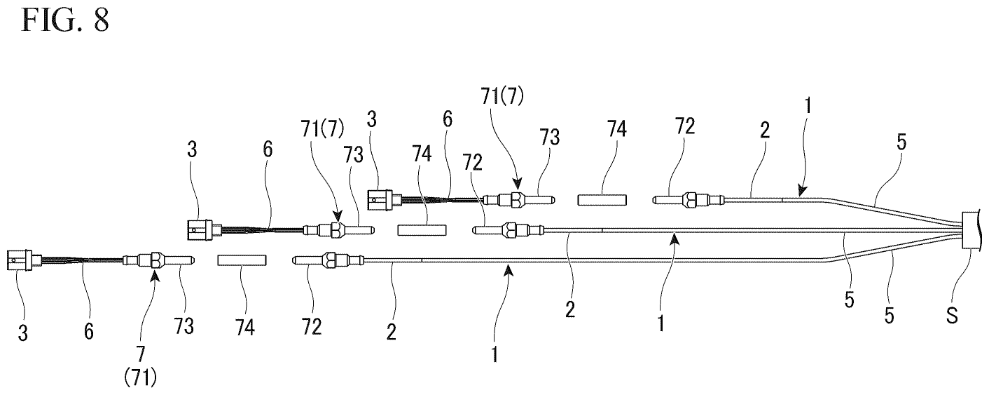

When producing the optical cable structure, first, as shown in FIGS. 7 and 8, the optical connector 3 is terminated at a first end portion (distal portion) 6A of the distal-side optical fiber 6 in the longitudinal direction (first step). The termination work of the optical connector 3 in the first step includes an insertion work of inserting the distal-side optical fiber 6 into the optical connector 3, a polishing work of polishing the connection end face 31 of the optical connector 3 and the distal end of the distal-side optical fiber 6 exposed on the connection end face 31, and an inspection work of inspecting an optical loss of the distal end of the distal-side optical fiber 6 exposed on the connection end face 31. In addition, in the first step of the present example, the distal-side connector 73 is terminated at a second end portion (proximal portion) 6B of the distal-side optical fiber 6. The termination work of the distal-side connector 73 may include the same insertion work, polishing work, and inspection work as the above-described termination work of the optical connector 3.

The first step is performed on the plurality of distal-side optical fibers 6. In the present example, the lengths of the plurality of distal-side optical fibers 6 are preset before the first step such that the lengths of the plurality of distal-side optical fibers 6 are equal to each other.

In addition, when producing the optical cable structure, the plurality of proximal-side optical fibers 5 are derived from the end portion of the sheath S for the optical cable C (second step). In the second step of the present example, the lengths of the plurality of proximal-side optical fibers 5 are set such that the lengths of the plurality of proximal-side optical fibers 5 are different from each other. In addition, in the second step of the present example, the proximal-side connector 72 is terminated at the distal portion of the proximal-side optical fiber 5. The termination work of the proximal-side connector 72 may include the same insertion work, polishing work, and inspection work as described above.

The second step may be performed, for example, before or after the first step, or simultaneously with the first step.

After the first step and the second step, as shown in FIGS. 2 and 3, the second end portion (proximal portion) 6B of each of the plurality of distal-side optical fibers 6 is connected to the distal portion of each of the plurality of proximal-side optical fibers 5 (third step). By performing the third step, the derivation optical fiber 2 having the proximal-side optical fiber 5 and the distal-side optical fiber 6 is configured. In addition, the connector-equipped optical fiber 1 having the derivation optical fiber 2 and the optical connector 3 and extending from the end portion of the sheath S is configured.

In the third step of the present example, the proximal-side optical fiber 5 and the distal-side optical fiber 6 are connected to each other by the connector connecting portion 71. Specifically, the proximal-side optical fiber 5 and the distal-side optical fiber 6 are connected to each other by butting the proximal-side connector 72 provided at the distal portion of the proximal-side optical fiber 5 and the distal-side connector 73 provided at the second end portion (proximal portion) 6B of the distal-side optical fiber 6 against each other by using the adapter 74.

In the production method of the present example, as described above, before the first step, the lengths of the plurality of distal-side optical fibers 6 are set such that the lengths of the plurality of distal-side optical fibers 6 are equal to each other. In addition, in the second step, the lengths of the plurality of proximal-side optical fibers 5 are set such that the lengths of the plurality of proximal-side optical fibers 5 are different from each other. For this reason, in the state after the third step, the lengths of the plurality of derivation optical fibers 2 are different from each other.

As described above, the method for producing the optical cable structure is completed.

As described above, in the optical cable structure and the method for producing the optical cable structure according to the first example, the lengths of the plurality of derivation optical fibers 2 derived from the end portion of the sheath S are different from each other. For this reason, the plurality of optical connector 3 provided at the corresponding distal portions of the plurality of derivation optical fibers 2 can be located out of alignment in the derivation direction of the plurality of derivation optical fibers 2. Accordingly, it is possible to suppress the bulkiness of the plurality of optical connectors 3 in the radial direction of the optical cable C. Therefore, the plurality of connector-equipped optical fibers 1 can be accommodated in the tubular member 100 having a small diameter dimension.

In addition, in the optical cable structure and the method for producing the optical cable structure according to the first example, the distal-side optical fiber 6 can be connected to the proximal-side optical fiber 5 after the optical connector 3 is terminated at the distal portion (first end portion) 6A of the distal-side optical fiber 6. That is, the termination work of the optical connector 3 can be performed before the distal-side optical fiber 6 is connected to the proximal-side optical fiber 5. For this reason, even if the lengths of the plurality of derivation optical fibers 2 are different from each other in the optical cable structure after production, the termination work of the optical connectors 3 for the plurality of derivation optical fibers 2 accommodated in the tubular member 100 can be easily performed. Specifically, since the positions of the distal portions (first end portions) 6A of the plurality of distal-side optical fibers 6 can be easily aligned, the termination work (particularly the polishing work and the inspection work) of the optical connector 3 for the distal-side optical fiber 6 can be easily performed.

In addition, in the optical cable structure and the method for producing the optical cable structure according to the first example, the lengths of the plurality of proximal-side optical fibers 5 extending from the end portion of the sheath S are different from each other. For this reason, the plurality of connecting portions 7 provided at the corresponding distal portions of the plurality of proximal-side optical fibers 5 can be located out of alignment in the longitudinal direction of the derivation optical fibers 2. Accordingly, it is possible to suppress the bulkiness of the plurality of connecting portions 7 in the radial direction of the optical cable C. Therefore, the plurality of connector-equipped optical fibers 1 can be easily accommodated in the tubular member 100 having a small diameter dimension. In the first example, the above effect is particularly useful because the diameter dimension of the connector connecting portion 71 is larger than the diameter dimension of the derivation optical fiber 2.

In addition, in the optical cable structure and the method for producing the optical cable structure according to the first example, the lengths of the plurality of distal-side optical fibers 6 are equal to each other. Accordingly, the optical cable structure can be produced by using the plurality of distal-side optical fibers 6 having the same length. Therefore, it is possible to efficiently produce the optical cable structure.

In addition, in the optical cable structure and the method for producing the optical cable structure according to the first example, the proximal-side optical fiber 5 and the distal-side optical fiber 6 are mechanically connected to each other by the connector connecting portion 71. Accordingly, the proximal-side optical fiber 5 and the distal-side optical fiber 6 can be easily connected to each other without using a device such as a fusion splicer.

### Second Example

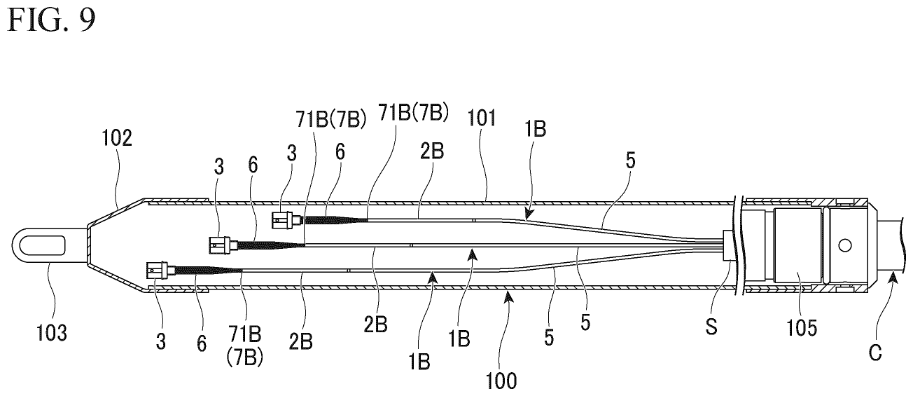

Next, an optical cable structure and a method for producing the optical cable structure according to a second example of one or more embodiments will be described with reference to FIGS. 9 to 12. In the following description, the configurations that are the same as those already described will be given the same reference signs, and duplicate descriptions thereof will be omitted.

As shown in FIG. 9, similar to the first example, the optical cable structure of the second example is derived from the end portion of the sheath S of the optical cable C and has a plurality of connector-equipped optical fibers 1B accommodated in the tubular member 100. In addition, a derivation optical fiber 2B of each connector-equipped optical fiber 1B has a connecting portion 7B that connects the proximal-side optical fiber 5 and the distal-side optical fiber 6.

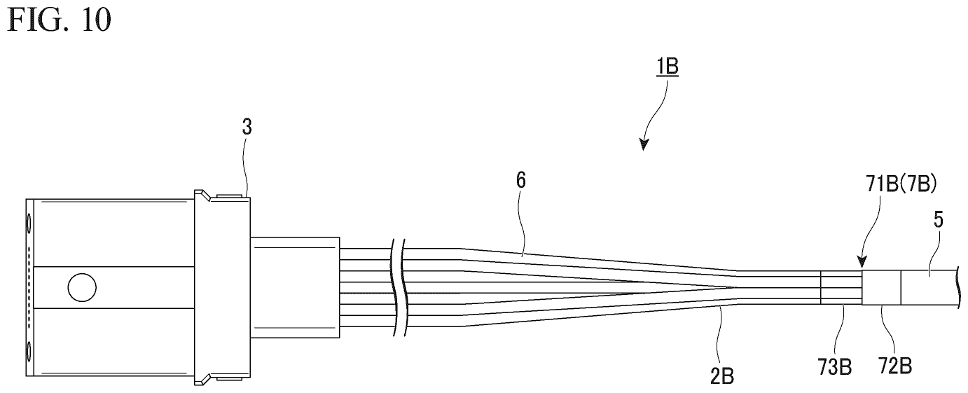

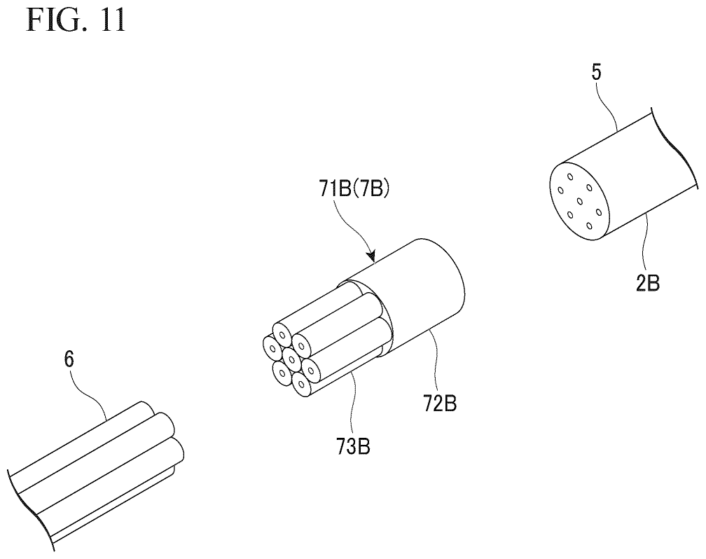

The connecting portion 7B of the second example is a fusion-splicing portion 71B that fusion-splices the proximal-side optical fiber 5 and the distal-side optical fiber 6 to each other. As shown in FIGS. 10 and 11, the fusion-splicing portion 71B of the second example is configured separately from the proximal-side optical fiber 5 and the distal-side optical fiber 6.

The fusion-splicing portion 71B has a proximal-side portion 72B and a distal-side portion 73B. The proximal-side portion 72B includes a multi-core fiber having a plurality of cores. The cross-sectional shape of the proximal-side portion 72B is the same as the cross-sectional shape of the proximal-side optical fiber 5 shown in FIG. 4. The distal-side portion 73B includes a plurality of single-core fibers each having one core. The cross-sectional shape of the distal-side portion 73B is the same as the cross-sectional shape of the distal-side optical fiber 6 on the proximal portion side shown in FIG. 5. The proximal-side portion 72B and the distal-side portion 73B are arranged in the longitudinal direction (left-right direction in FIG. 10) of the cores and joined to each other by fusion or the like. Accordingly, the plurality of cores of the proximal-side portion 72B and the plurality of cores of the distal-side portion 73B are optically coupled to each other individually. According to such a configuration, when an optical connector (for example, MT ferrule) is wired to a terminal of an optical fiber, the alignment work in the rotation direction of the optical fiber (the direction around the axis of the optical fiber) is required in a case where the terminal of the optical fiber located on the optical connector side is a multi-core fiber, and the rotation directionality of the optical fiber is lost in a case where the terminal of the optical fiber is a single-core fiber. Therefore, the above-described alignment work becomes unnecessary.

The proximal-side portion 72B of the fusion-splicing portion 71B is fusion-spliced with the distal portion of the proximal-side optical fiber 5. In addition, the distal-side portion 73B of the fusion-splicing portion 71B is fusion-spliced with the proximal portion of the distal-side optical fiber 6. Accordingly, the cores 52 (see FIG. 4) of the proximal-side optical fiber 5 and the cores 62 (see FIG. 5) of the distal-side optical fiber 6 are optically coupled to each other via the core of the fusion-splicing portion 71B (the proximal-side portion 72B and the distal-side portion 73B).

In the second example, the length of the fusion-splicing portion 71B is shorter than the lengths of the proximal-side optical fiber 5 and the distal-side optical fiber 6. In addition, in the second example, the lengths of the fusion-splicing portions 71B are equal to each other between a plurality of the derivation optical fibers 2B.

Although not shown, the fusion-splicing portion 71B may have, for example, a protective sleeve that protects a fused portion between the proximal-side optical fiber 5 and the distal-side optical fiber 6. In this case, the diameter dimension of the fusion-splicing portion 71B is larger than the diameter dimension of the derivation optical fiber 2.

Next, a method for producing the optical cable structure according to the second example will be described.

The production method of the second example is different from the production method of the first example in that the distal-side connector 73 (see FIGS. 7 and 8) is not terminated at the distal-side optical fiber 6 in the first step and the proximal-side connector 72 (see FIGS. 7 and 8) is not terminated at the proximal-side optical fiber 5 in the second step.

In addition, the production method of the second example is different from the production method of the first example in terms of a method of connecting the second end portion (proximal portion) 6B of each of the plurality of distal-side optical fibers 6 to the distal portion of each of the plurality of proximal-side optical fibers 5 in the third step.

Hereinafter, the third step in the production method of the second example will be described.

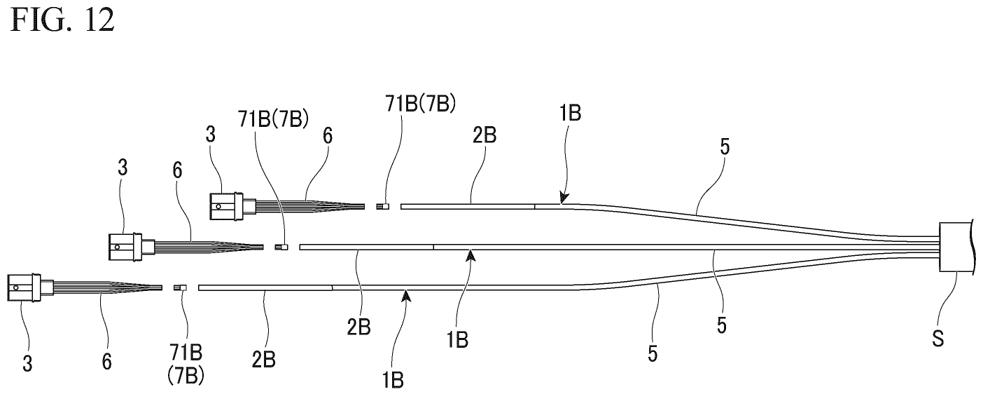

As shown in FIGS. 10 to 12, in the third step of the second example, the distal portion of the proximal-side optical fiber 5 and the proximal portion of the distal-side optical fiber 6 are fusion-spliced with each other by the fusion-splicing portion 71B. Specifically, first, as shown in FIGS. 11 and 12, the fusion-splicing portion 71B is disposed between the distal portion of the proximal-side optical fiber 5 and the proximal portion of the distal-side optical fiber 6. Thereafter, as shown in FIG. 10, the distal portion of the proximal-side optical fiber 5 is fusion-spliced with the proximal-side portion 72B of the fusion-splicing portion 71B. In addition, the proximal portion of the distal-side optical fiber 6 is fusion-spliced with the distal-side portion 73B of the fusion-splicing portion 71B.

After the first step and the second step, the third step of the above-described second example is performed, thereby completing the production method of the second example.

According to the second example, the same effects as those of the first example are exhibited.

In addition, according to the second example, the proximal-side optical fiber 5 and the distal-side optical fiber 6 are fusion-spliced with each other. Accordingly, the proximal-side optical fiber 5 and the distal-side optical fiber 6 can be connected to each other with higher reliability.

In addition, in the second example, the fusion-splicing portion 71B is configured separately from the proximal-side optical fiber 5 and the distal-side optical fiber 6. In addition, the fusion-splicing portion 71B has the proximal-side portion 72B including multi-core fibers similar to the proximal-side optical fiber 5, and the distal-side portion 73B including a plurality of single-core fibers similar to the distal-side optical fiber 6.

For this reason, the proximal-side optical fiber 5 and the distal-side optical fiber 6 can be connected to each other by the fusion-splicing between the multi-core fibers and the fusion-splicing between the plurality of single-core fibers. Here, the fusion-splicing between the same type of optical fibers can be performed more easily than the fusion-splicing between different types of optical fibers (that is, the fusion-splicing between the multi-core fibers and the plurality of single-core fibers). Accordingly, the proximal-side optical fiber 5 and the distal-side optical fiber 6 can be easily fusion-spliced with each other.

In addition, a large number of the fusion-splicing portions 71B each having the proximal-side portion 72B and the distal-side portion 73B can be produced in advance before the proximal-side optical fiber 5 and the distal-side optical fiber 6 are fusion-spliced with each other. Accordingly, it is possible to efficiently perform the fusion-splicing between the plurality of proximal-side optical fibers 5 and the plurality of distal-side optical fibers 6.

From the above, the optical cable structure can be efficiently produced.

In the second example, for example, the lengths of the fusion-splicing portions 71B may be different from each other between the plurality of derivation optical fibers 2B. For example, the lengths of the plurality of derivation optical fibers 2B may be made different from each other by making the lengths of the fusion-splicing portions 71B different from each other between the plurality of derivation optical fibers 2B.

In the second example, for example, the length of the fusion-splicing portion 71B may be equal to or longer than the lengths of the proximal-side optical fiber 5 and the distal-side optical fiber 6.

In the second example, the fusion-splicing portion 71B may be configured by, for example, the distal portion of the proximal-side optical fiber 5 and the proximal portion of the distal-side optical fiber 6. That is, the proximal-side optical fiber 5 and the distal-side optical fiber 6 may be directly fusion-spliced with each other.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

In one or more embodiments, for example, the plurality of proximal-side optical fibers 5 may have the same length. In this case, the lengths of the plurality of derivation optical fibers 2 and 2B may be made different from each other, for example, by making the lengths of the plurality of distal-side optical fibers 6 different from each other.

In one or more embodiments, both the proximal-side optical fiber 5 and the distal-side optical fiber 6 may be, for example, the multi-core fibers 51, or may be configured by, for example, the plurality of single-core fibers 61. In addition, the proximal-side optical fiber 5 and the distal-side optical fiber 6 may be one single-core fiber 61.

In the method for producing optical cable structure according to one or more embodiments, for example, in the first step, the lengths of the plurality of distal-side optical fibers 6 may be set such that the lengths of the plurality of distal-side optical fibers 6 are different from each other. In this case, in the second step, for example, similar to the above embodiments, the lengths of the plurality of proximal-side optical fibers 5 may be set such that the lengths of the plurality of proximal-side optical fibers 5 are different from each other, or for example, the lengths of the plurality of proximal-side optical fibers 5 may be set such that the lengths of the plurality of proximal-side optical fibers 5 are equal to each other. Even in a case where the lengths of the plurality of distal-side optical fibers 6 or the lengths of the plurality of proximal-side optical fibers 5 are set in this way, the lengths of the plurality of derivation optical fibers 2 and 2B in the optical cable structure after production can be made different from each other.

In one or more embodiments, the lengths of all the derivation optical fibers 2 and 2B extending from the end portion of the sheath S may not be different from each other. For example, the lengths of some derivation optical fibers 2 and 2B among all the derivation optical fibers 2 and 2B extending from the end portion of the sheath S may be equal to each other. For example, the plurality of derivation optical fibers 2 and 2B extending from the end portion of the sheath S may be divided into a plurality of groups, the lengths of the plurality of derivation optical fibers 2 and 2B constituting the same group are made equal to each other, and the lengths of the different groups of derivation optical fibers 2 and 2B may be made different from each other. In this case, the plurality of optical connectors 3 provided at the distal ends of the plurality of derivation optical fibers 2 and 2B constituting the same group are disposed at the same position in the derivation direction of the derivation optical fibers 2 and 2B. In addition, the optical connectors 3 provided at the distal ends of the different groups of derivation optical fibers 2 and 2B are located out of alignment in the derivation direction of the derivation optical fibers 2 and 2B.

### REFERENCE SIGNS LIST

1, 1B: Connector-equipped optical fiber
2, 2B: Derivation optical fiber
3: Optical connector
5: Proximal-side optical fiber
6: Distal-side optical fiber
7, 7B: Connecting portion
51: Multi-core fiber
52: Core
61: Single-core fiber
62: Core
71: Connector connecting portion
71B: Fusion-splicing portion
100: Tubular member
C: Optical cable
S: Sheath

1. An optical cable structure comprising:
connector-equipped optical fibers, derived from an end portion of a sheath of an optical cable, that are accommodated in a tubular member, wherein
each of the connector-equipped optical fibers includes:
a derivation optical fiber from the end portion of the sheath; and
an optical connector disposed at a distal portion of the derivation optical fiber,
lengths of at least some of the derivation optical fibers are different from each other,
each of the derivation optical fibers includes:
a proximal-side optical fiber on an end portion side of the sheath;
a distal-side optical fiber on an optical connector side; and
a connecting portion connecting the proximal-side optical fiber to the distal-side optical fiber, and
the connecting portions are disposed in the tubular member when the connector-equipped optical fibers are accommodated in the tubular member.

2. The optical cable structure according to claim 1, wherein lengths of the proximal-side optical fibers extending from the end portion of the sheath are different from each other.

3. The optical cable structure according to claim 2, wherein lengths of the distal-side optical fibers are equal to each other.

4. The optical cable structure according to claim 1, wherein each of the connecting portions is a fusion-splicing portion that fusion-splices the proximal-side optical fiber and the distal-side optical fiber.

5. The optical cable structure according to claim 1, wherein each of the connecting portions is a connector connecting portion mechanically connecting the proximal-side optical fiber to the distal-side optical fiber.

6. The optical cable structure according to claim 1, wherein in each of the derivation optical fibers:
the proximal-side optical fiber is a multi-core fiber,
the distal-side optical fiber is configured by single-core fibers, and
the connecting portion optically couples each of cores of the multi-core fiber to a respective one of cores of the single-core fibers.

7. A method for producing an optical cable structure including connector-equipped optical fibers, the method comprising:
terminating an optical connector at a first end portion of each of distal-side optical fibers;
leading out proximal-side optical fibers from an end portion of a sheath of an optical cable;
connecting a second end portion of each of the distal-side optical fibers to a distal portion of each of the proximal-side optical fibers after the terminating of the optical connector and the leading out of the proximal-side optical fibers to form the connector-equipped optical fibers, wherein
the connector-equipped optical fibers:
are derived from the end portion of the sheath and accommodated in a tubular member, and
each include the optical connector and a derivation optical fiber including one of the proximal-side optical fibers and one of the distal-side optical fibers; and
setting one or both of lengths of the proximal-side optical fibers and lengths of the distal-side optical fibers before the connecting of the second end portion such that lengths of at least some derivation optical fibers among the derivation optical fibers derived from the end portion of the sheath are different from each other.
